(19) United States
(12) Patent Application Publication
(10) Pub. No.: US 2007/0163408 A1
(43) Pub. Date: Jul. 19, 2007

(54) Table saw guard

(76) Inventors: William C. Buck, Clemson, SC (US); David G. Peot, Easley, SC (US)

Correspondence Address: BRINKS HOFER GILSON & LIONE, P.O. BOX 10395, CHICAGO, IL, 60610, US

(21) Appl. No.: 11/333,854

(22) Filed: Jan. 17, 2006

(51) Int. Cl. B26D 7/06; B27B 3/28

(52) U.S. Cl. 83/438; 83/440.2

(57) ABSTRACT

An improved riving knife/guard assembly for a table saw allows the guard to be removed and attached without the use of any tools, provides a clear view of the work zone, blade and workpiece, and is easily adjustable to accommodate different size workpieces and cutting angle. The assembly includes a riving knife extending upward from the table substantially coplanar with the saw blade and a guard that releasably attaches to the riving knife with a rotatable latch with the guard at least partially surrounding the saw blade.

### BACKGROUND

Typical table saws include a base or frame having a flat table top or supporting a flat table top. The table top generally includes a slot through which a cutting member, such as a circular saw, protrudes above the table top. Often, a riving knife, or splitter, is mounted directly in-line with the saw blade. The riving knife operates to keep separate the two portions of the workpiece that have been cut to prevent the workpiece from binding on the saw blade, which reduces the possibility of workpiece kickback. Many table saws also include a guard to protect the operator from potentially serious injury caused by accidental contact with the saw blade. The guard is located to prevent the operator from contacting the saw blade while in use.

Many types of riving knives and guard assemblies have been used in the past. However, these assemblies have often been difficult to use because they are typically flimsy or obstruct the operator's view of the workpiece with respect to the saw blade, or reference marks or scales used to align the workpiece. As a result, many users operate the table saw with the guard and the riving knife removed. This results in a higher probability of accidents and injuries that may occur due to accidental user contact with the rotating saw blade. Additionally, the removal and replacement of the guard and the riving knife often requires the use of tools and multiple procedural steps that make the process complicated and difficult, such that the user often removes these components for a specific project and never replaces them.

Accordingly, it is desired to provide a guard and a riving knife that protect the user from accidentally contacting the rotating saw blade during operation, while providing the user with a sufficient viewing area of the zone of contact between the workpiece and the saw blade. If the user can view the saw blade and the workpiece with the guard installed, the user may not be motivated to operate the table saw with the guard removed.

Additionally, it is desired to provide a guard that is easily removable and replaceable on the riving knife so that the user will replace the guard on the riving knife after it has been removed, rather than continue to operate the table saw without the guard.

### BRIEF SUMMARY

A table saw is provided that includes a table with an aperture to receive a portion of a rotatable saw blade extending from below the table and a riving knife that extends through the aperture from below the table.

The table saw may have a top guard attached to the riving knife with a latch. The riving knife includes a slot and a tongue and the top guard is provided with a retention pin and a latch to respectively engage the slot and the tongue. The retention pin is inserted into the slot in the riving knife and a first portion of the latch is rotated until it engages the tongue and second portion of the latch is rotated in the opposite direction to place the first portion in tension.

Advantages of the present invention will become more apparent to those skilled in the art from the following description of the preferred embodiments of the invention that have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

The features and advantages of the present invention may be better understood by reference to the accompanying drawings in which like reference numerals refer to like elements.

FIG. 1 is a perspective view of a table saw incorporating a riving knife/guard assembly according to the present invention.

FIG. 2 is a side view of a riving knife/guard assembly.

FIG. 3 is a cross-sectional view of the connection between the top guard and the riving knife.

FIG. 4 is top perspective view of the top guard.

FIG. 5 is a bottom perspective view of the top guard.

FIG. 6 is a top view of the top guard.

FIG. 7 is a perspective view of the latch.

FIG. 8 is a side view of the riving knife.

FIG. 9 is a perspective view of the riving knife/guard assembly showing a side guard rotated away from contact with the table surface.

### DETAILED DESCRIPTION

While this invention is susceptible of several different embodiments, this specification and the accompanying drawings disclose only some specific forms as examples of the invention. The invention is not intended to be limited by the descriptions in this specification or the drawings. Instead, the scope of the invention is provided in the claims.

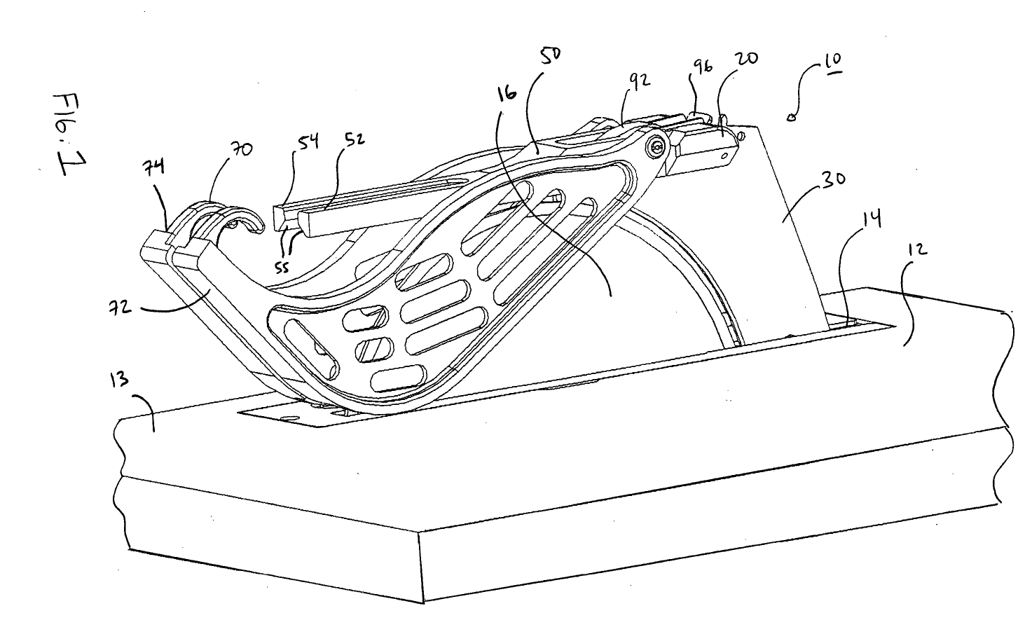

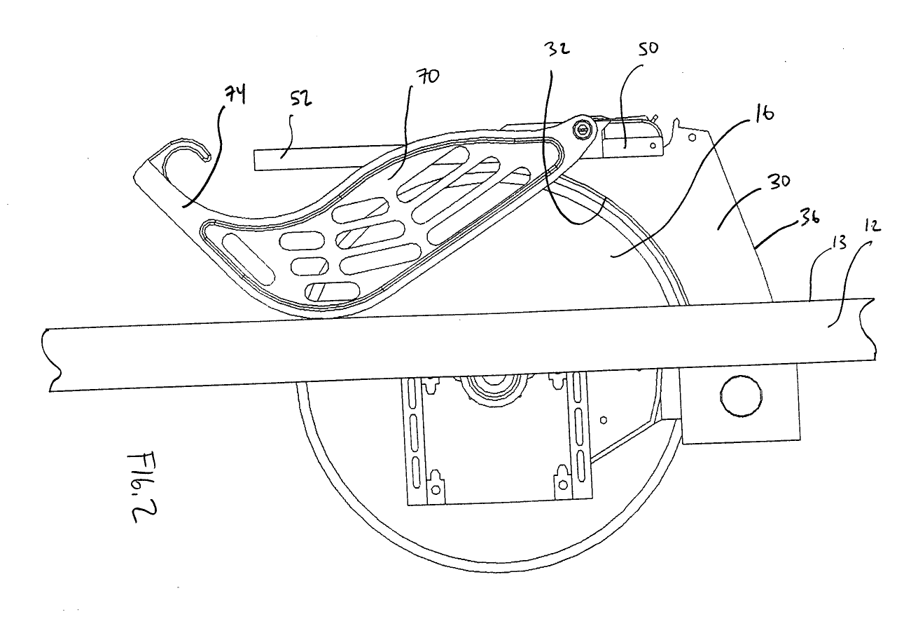

Turning now to FIGS. 1-9, a table saw 10 having one embodiment of the inventive riving knife/guard assembly 20 is provided. The table saw 10 includes a table top 12 with a top surface 13. The table top 12 includes a slot 14, or aperture, that extends through the table 12. A saw blade 16 is conventionally mounted to a motor and carriage (both not shown) that is located under the table top 12. A portion of the saw blade 16 protrudes through the slot 14. The portion of the saw blade 16 that protrudes through the slot 14 is the operative portion for cutting a workpiece (not shown). The knife/guard assembly 20 includes a riving knife 30, a top guard 50, and a latch 90 to removeably attach the top guard 50 to the riving knife 30.

The riving knife 30 extends upward from the top surface 13 of the table saw. The riving knife 30 may be mounted to the table saw 10. For example, the riving knife 30 may be mounted to the carriage (not shown) under the table top 12 in such a manner so that it is centered behind or aligned with the saw blade 16. In some embodiments, the riving knife 30 may be mounted for movement in conjunction with the saw blade 16.

The riving knife 30 operates to keep the cut portion of the workpiece (not shown) split or separated after it is cut and as the remainder of the workpiece is fed through the saw blade 16. Splitting or keeping the cut portions of the workpiece separated helps to prevent potential binding of the saw blade 16 and the workpiece during operation. The spacing of the riving knife 30 from the saw blade 16 may range from about 3 mm (0.12 inches) to 8 mm (0.31 inches) to reduce the possibility for binding and kickback.

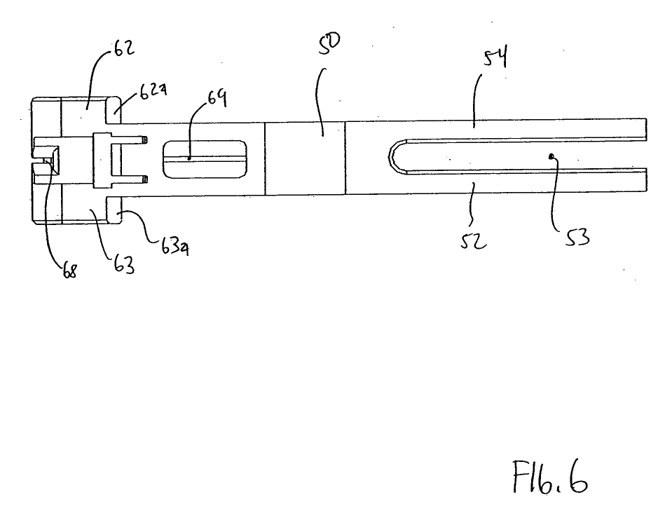

A top guard 50 as explained in detail below is attached to the riving knife 30. Preferably, the top guard 50 is attached to an upper portion of the riving knife 30 so that the workpiece does not contact the top guard 50. The top guard 50 is formed with a first finger 52 and a second finger 54 that each extend forwardly from the point of contact between the top guard 50 and the riving knife 30. The two fingers 52, 54 are sized to extend past the front edge 17 of the saw blade 16. Thus, the two fingers 52, 54 provide protection from the user contacting the saw blade 16 from above the saw blade 16. The two fingers 52, 54 are spaced from each other to form a gap 53 (best shown in FIG. 6) that provides a view of the saw blade 16 and the workpiece as it is moved toward and makes contact with the saw blade 16. The gap 53 provides the user with a suitable view of alignment markings (not shown) on the workpiece to allow the user to precisely cut the workpiece with the saw blade 16.

The fingers 52, 54 may have interior chamfered edges 55 along a portion of their length. The chamfered edges 55 increase the view of the cutting zone, as well as the blade 16 and workpiece, when these are viewed at an oblique angle, while maximizing the distance from the blade 16 to the operator, and minimizing the width of the gap 53.

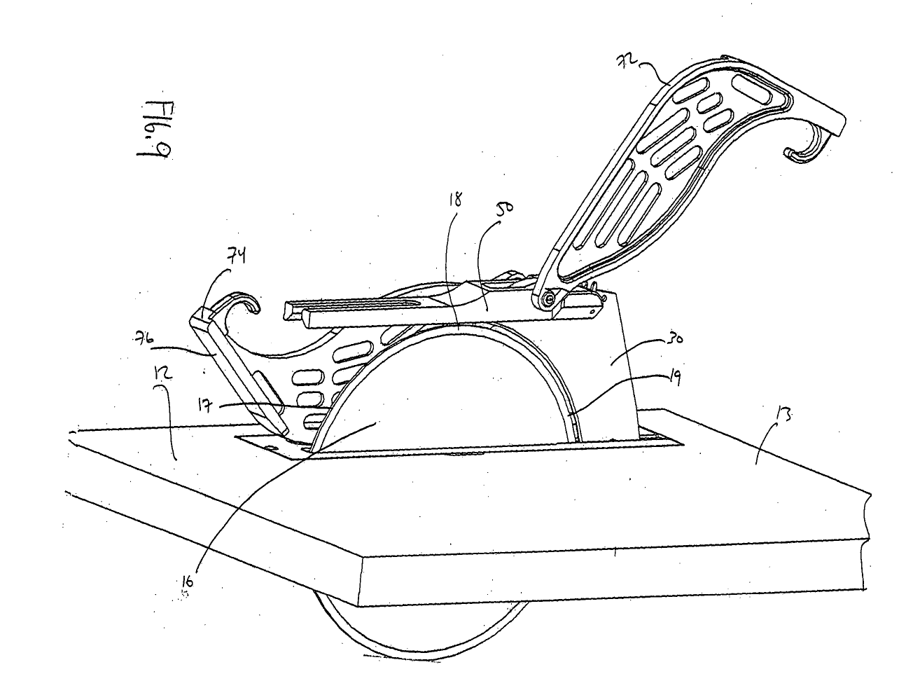

The top guard 50 may also include a side guard 70 that is pivotably mounted to the top guard 50. The side guard 70 normally contacts the workpiece yet allows the workpiece to move into the cutting zone while providing a protective surface that surrounds the front and the sides of the exposed portion of the saw blade 16. As best seen in FIG. 9, the side guard 70 has two side pieces 72 and 74 that extend beyond the fingers 52, 54 of the top guard 50. The side pieces 72, 74 provide protection from the saw blade 16 both before and after the workpiece is cut. Likewise, the side guard 70 has a front portion 76 that contacts an operator's hands or fingers that are on top of the workpiece as it is fed to be cut, thus providing a tactile warning that the operator's hands or fingers may be near the saw blade 16. The side guard 70 is designed not to interfere with measuring, aligning, or setting up the workpiece due to its pivotal mounting.

In some embodiments, the side guard 70 is provided with a sensing apparatus that provides an audible or visual signal when the user contacts the side guard 70 when the saw blade 16 is rotating. The audible signal can be a bell or an alarm, the visual signal can be a warning light. In other embodiments, the saw blade 16 could stop rotating when the user contacts the side guard 70. This sensing mechanism could be activated based on a change in capacitance sensed by the side guard 70 or by another type of sensing means that is known to those of ordinary skill in the art.

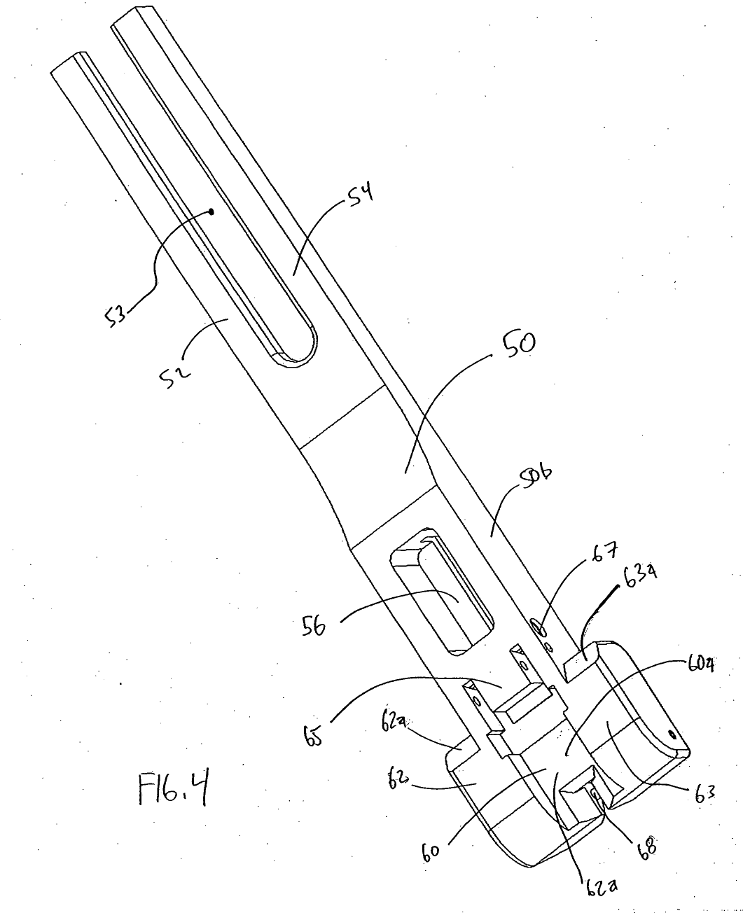

Each of the sides 72, 74 of the side guard 70 can be independently lifted and rotated onto a pair of stops 62, 63 located on either side of the top guard 50, as best seen in FIG. 4. The top guard 50 remains in place when the side guard 70 is rotated into a raised position (FIG. 9) from its lowered position, where it rests on the table surface 12, or on a surface of the workpiece if present on the table top 12. The formation of a two-piece side guard allows a further range of potential tilt of the saw blade 16 with respect to the table surface 12 without requiring the side guard 70 to be removed. Similarly, the side guard 70 with discrete side pieces 72, 74 can be used with a workpiece that does not have a flat surface that is parallel to the table surface 12. Because of the convenience of this side guard 70 design, the user is less likely to remove the side guard 70 from the top guard 50. Additionally, the side guard 70 provides additional protection to the user because a greater amount of the side and front surfaces of the saw blade are enclosed by the side guard 70 during angled cuts (or when cutting workpieces with angled surfaces) than would be available with a side guard having arms that are attached together on either side of the saw blade 16.

In one embodiment, the riving knife 30 is formed from a flat plate that extends through the slot 14 in the table top 12. The riving knife 30 is movably mounted to the table saw 10. The riving knife 30 is formed to maintain separation between the two portions of the workpiece after the workpiece is cut by the saw blade 16. The forward edge 32 of the riving knife 30 is formed to be concave with a radius slightly larger than the radius of the saw blade 16. This shape allows the forward edge 32 of the riving knife 30 to substantially surround the rear edge 19 of the saw blade 16 while the saw blade 16 is rotating to provide protection for the user against accidental contact between the user and the rear edge 19 of the saw blade 16.

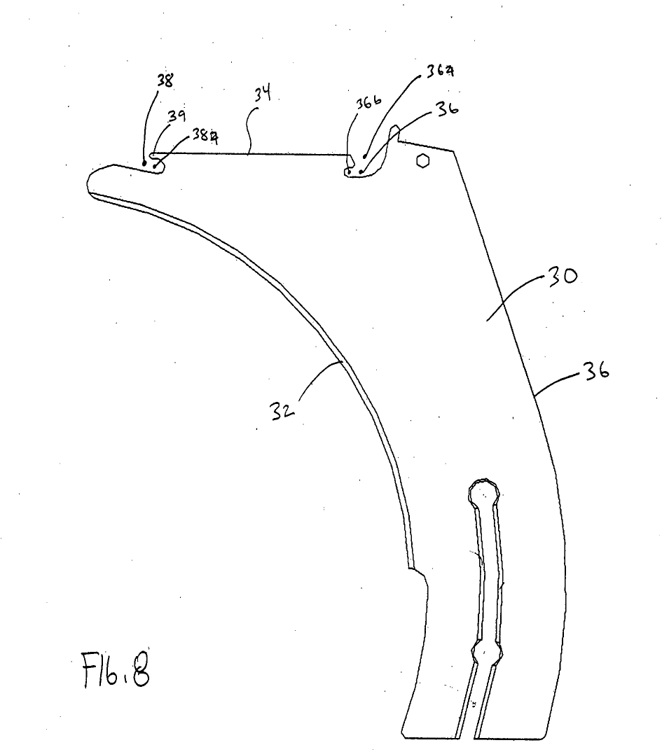

As best shown in FIG. 8, the riving knife 30 includes a top edge 34. The top edge 34 of the riving knife 30 includes a first slot 38 near the forward most point of the riving knife 30 and a rear slot 36 near the rearward most point of the riving knife 30. The first slot 38 is preferably formed with a hook or a dogleg shape that extends downward from the top edge 34 and a cavity 38a extending rearwardly within the riving knife 30. The top edge 34 forms a tongue 39 that is above the cavity 38a of the first slot 38. The second slot 36 is formed with substantially the same shape as the first slot 38 although it is oriented in the opposite direction from the first slot 38. The second slot 36 includes a first portion 36a that extends downward from the top edge 34 of the riving knife 30 and a second cavity 36b that extends forwardly within the riving knife 30 and substantially perpendicular to the first portion 36a.

The top guard 50 is best seen in FIGS. 4-7. The top guard 50 includes a first arm 52 and a second arm 54 that each extend above the saw blade 16 when the top guard 50 is attached to the riving knife 30. The arms 52, 54 extend from the riving knife 30 forward the front edge 17 portion of the saw blade 16. The arms 52, 54 are separated from each other to define a gap 53 to allow the user to view the rotating saw blade 16 and its contact with a workpiece when presented to the front edge 17 of the saw blade 16. The top guard 50 includes a forward cavity 56 and a rear cavity 60 rearward of the first and second fingers 52, 54. The forward and rear cavities 56, 60 receive and retain the components of the latch 90, which are discussed in detail below. In addition to the components of the latch 90, the rear cavity 60 includes apertures to accept a pin 68. The pin 68 may be positioned and retained within the second cavity 36b of the rear slot 36 in the riving knife 30 when attaching the top guard 50 to the riving knife 30.

The top guard 50 additionally includes two stops, a right stop 62 and a left stop 63. As best seen in FIG. 4, the right stop 62 extends outwardly from a right surface 50a of the fork and the left stop 63 extends outwardly from a left surface 50b. The stops 62, 63 may each include a beveled surface 62a, 63a, respectively. Each of the beveled surfaces 62a, 63a limit the potential range of rotation of the two side guards 72, 74 (discussed above).

The top guard 50 further includes apertures 67 that extend blindly into the side surfaces 50a, 50b of the top guard 50 and that accept pins, or other similar fasteners that are known to those of skill in the art, to attach the right side piece 72 of the side guard 70 to the right side surface 50a and the left side piece 74 of the side guard 70 to the left side surface 50b of the top guard 50. Preferably, the apertures 67 are formed forward of the right and left stops 62, 63, in a position to allow the side pieces 72, 74 to rotate to a position where they do not contact the workpiece when it contacts the saw blade 16 but also to avoid contacting the workpiece after it has passed beyond the riving knife 30.

The top guard 50 includes a projection 65 that extends rearwardly into the rear cavity 60. The projection 65 includes holes that blindly extend through the projection 65 and the side surfaces 50a, 50b to accept a pin 97 that extends through the locking member 96, to rotatably connect the latch 90 to the top guard 50. Alternatively, the latch 90 can be rotatably connected to the top guard 50 by other methods that are understood by those of ordinary skill in the art.

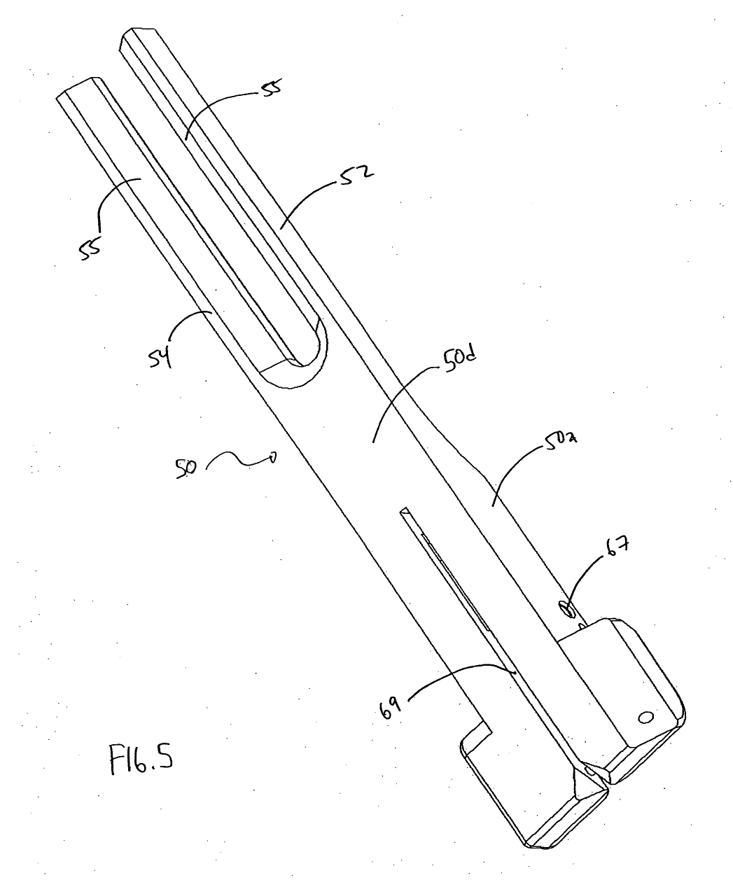

As best shown in FIG. 5, the bottom surface 50d of the top guard 50 preferably includes a groove 69 that accepts the top edge 34 of the riving knife 30 when the top guard 50 is positioned on the riving knife 30.

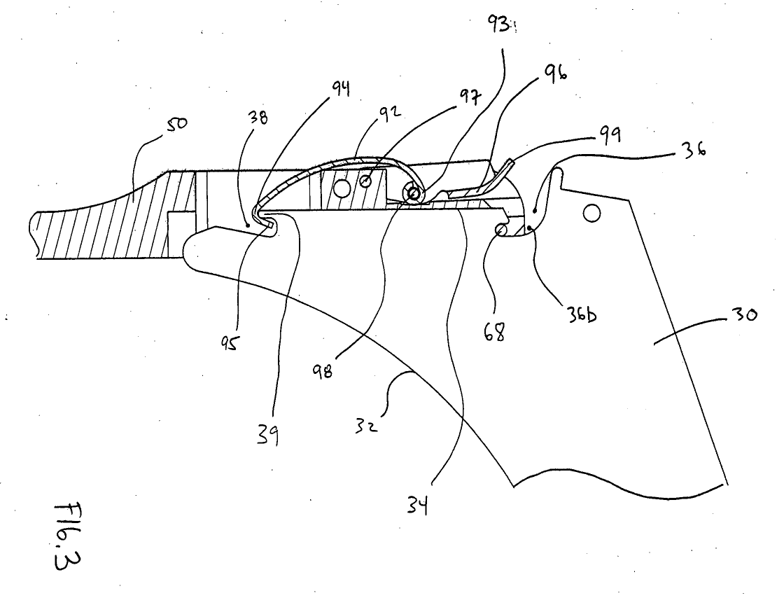

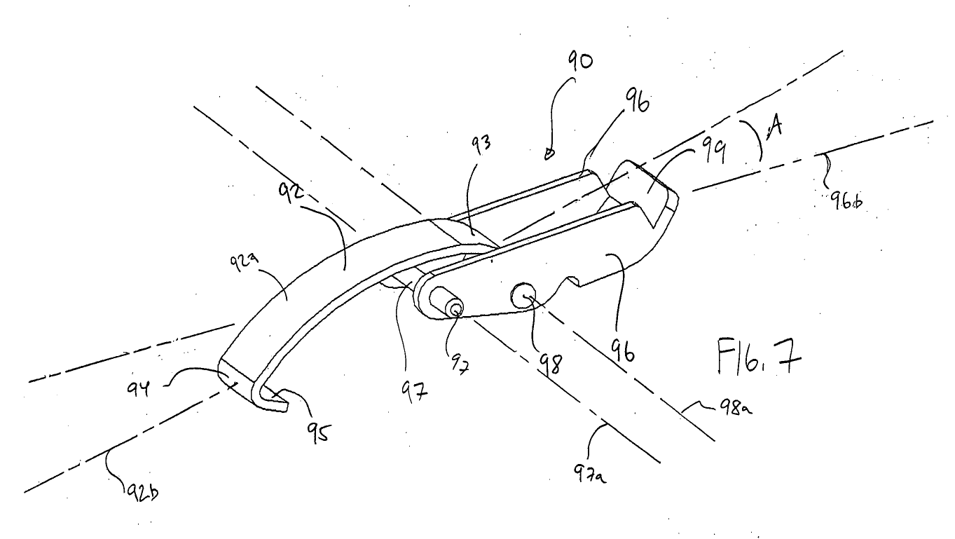

Referring now to FIGS. 3 and 7, the latch 90 includes a swinging member 92 and a locking member 96. The swinging member 92 is rotatably connected to the locking member 96 with a pin 98 that is inserted into holes formed within the locking member 96 and holes formed at a first end 93, or proximal end, of the swinging member 92. The second end 94, or distal end, of the swinging member 92 is formed with a hook 95, or a curve. The hook 95 has an inner radius slightly larger than the radius of a distal end of the tongue 39 on the top edge 34 of the riving knife 30. The swinging member 92 is formed with a curved surface along the length of the swinging member 92. Specifically, the swinging member 92 is formed so that its top surface 92a is convex when viewed from the top of the top guard 50 (with the latch 90 connected to the top guard 50).

A locking member 96 is additionally provided on the latch 90. The locking member 96 is rotatably connected to the projection 65 in the top guard 50 with a pin 97 that extends through a first end of the locking member 96 as discussed above and forms a rotational axis 97a with respect to the top guard 50. The locking member 96 is also rotatably connected to the swinging member 92 to allow the swinging member 92 to engage the tongue 39 on the top edge 34 of the riving knife 30 about a second rotational axis 98a through the pin 98. After the swinging member 92 engages the tongue 39, the locking member 96 may be rotated in the opposite direction, until the locking member 96 contacts the bottom surface 60a of the second cavity 60 of the top guard 50. In this position an imaginary line, or axis, 92b through a proximal end 93 of the swinging member 92 and the hook 94, or distal end, of the swinging member 92 is substantially in-line with a longitudinal axis 96b of the locking member 96. This position of the locking member 96 places the swinging member 92 in tension and retains the engagement between the top guard 50 and the riving knife 30.

As can be understood by those of ordinary skill in the art, in other embodiments, the longitudinal axes 92b, 96b of each of the swinging member and the locking member 92, 96 may be at a pre-defined angle A with respect to each other when the locking member 96 contacts the bottom surface 60a of the second cavity 60 of the top guard 50 to retain the engagement between the swinging member 92 and the riving knife 30. In some embodiments, the pre-defined angle A may be oblique, and in other embodiments the pre-defined angle A may be zero degrees, such that the axes 92b, 96b are substantially parallel with each other. In still other embodiments, the locking member 96 may retain the swinging member 92 in position on the riving knife 30, with the locking member not contacting the bottom surface 60a of the second cavity 60 of the top guard.

A handle 99 extends from an end of the locking member 96 at an oblique angle and provides a surface that the user may hold to rotate the locking member 96 out of the second cavity 60. Rotation of the locking member 96 removes the tension in the swinging member 92 and allows it to be disengaged from the tongue 39. When the swinging member 92 is disengaged from the tongue 39, the top guard 50 can be slid rearwardly with respect to the riving knife 30 to allow the pin 68 to be removed from the second slot 36 in the riving knife 30, which allows the top guard 50 to be removed from the riving knife 30.

The foregoing disclosure is the best mode devised by the inventors for practicing this invention. It is apparent, however, that apparatus incorporating modifications and variations will be obvious to one skilled in the art. Inasmuch as the foregoing disclosure is intended to enable one skilled in the pertinent art to practice the instant invention, it should not be construed to be limited thereby but should be construed to include aforementioned obvious variations and be limited only by the spirit and scope of the following claims.

It is therefore intended that the foregoing detailed description be regarded as illustrative rather than limiting, and that it be understood that it is the following claims, including all equivalents, that are intended to define the spirit and scope of this invention.

1. A table saw comprising:
(a) a table including a slot to receive a portion of a rotatable saw blade extending therethrough from below the table;
(b) a riving knife extending upward from a top surface of the table substantially coplanar with the saw blade;
(c) a guard releasably attached to the riving knife with a rotatable latch, wherein the guard partially surrounds the saw blade.

2. The table saw of claim 1 further comprising a tongue extending from the top surface of the knife to receive the latch when the guard is attached to the riving knife.

3. The table saw of claim 2 further comprising a hook provided on the latch.

4. The table saw of claim 2 further comprising a recess in the top surface of the riving knife and a pin extending from the guard to engage the recess when the guard is attached to the riving knife.

5. The table saw of claim 2 wherein the latch further comprises a swinging member having a first end that includes the hook and a second end that is rotatably connected to a locking member.

6. The table saw of claim 5 wherein the locking member is rotatably connected to the guard at a first end of the locking member.

7. The table saw of claim 6 wherein the latch is rotatable to a locked position where the hook engages the tongue and the locking member is positioned to place the swinging member in tension and retain the guard on the riving knife.

8. The table saw of claim 6 wherein the locking member includes a handle formed on a second end of the locking member to allow the locking member to be rotated away from the locked position.

9. A combination riving knife/guard for use with a table saw comprising:
(a) a riving knife;
(b) a top guard; and
(c) a latch that is rotatably connected to the top guard about a first axis and removeably engageable with the riving knife to maintain attachment between the top guard and the riving knife.

10. The combination riving knife/guard of claim 9 wherein the latch includes a swinging member that can be rotated about the first axis to selectively engage a tongue in the riving knife.

11. The combination riving knife/guard of claim 10 wherein the swinging member includes a distal end that is formed as a hook.

12. The combination riving knife/guard of claim 10 wherein the tongue is located on a top edge of the riving knife.

13. The combination riving knife/guard of claim 10 wherein the latch further comprises a locking member that is rotatably attached to the top guard and the swinging member.

14. The combination riving knife/guard of claim 9 wherein the riving knife includes a rear slot and the top guard includes a pin that is positioned within the rear slot when the top guard is positioned on the riving knife.

15. The combination riving knife/guard of claim 14 wherein the top guard further comprises a bottom slot that receives the top edge of the riving knife when the top guard is engaged with the riving knife.

16. A table saw comprising:
(a) a table with a slot that receives a saw blade therethrough;
(b) a riving knife that extends through the slot from below the table and partially surrounds an edge of the saw blade;
(c) a top guard removeably connected to a top surface of the riving knife; and
(d) a latch comprised of a locking member that is rotatably connected to the top guard through a first axis and a swinging member that is rotatably connected to the locking member through a second axis, wherein the swinging member can be rotated so that a hook on the distal end of the swinging member engages a tongue on a top surface of the riving knife.

17. The table saw of claim 16 wherein the locking member includes a handle that extends from an end of the locking member to provide a convenient surface for the user to hold to rotate the locking member about the rotatable about the first axis.

18. The table saw of claim 16 further comprising a recess in the top surface of the riving knife and a pin extending from the guard to engage the recess when the guard is attached to the riving knife.

19. The table saw of claim 16 wherein the top guard is secured to the riving knife when the locking member is rotated about the first axis so that a longitudinal axis of the locking member is at a pre-defined angle with respect to a line between the distal end of the swinging member and the proximal end of the swinging member.

20. The table saw of claim 19 wherein the pre-defined angle is an oblique angle.
